(19) United States
(12) Patent Application Publication
(10) Pub. No.: US 2024/0172319 A1
(43) Pub. Date: May 23, 2024

(54) ADJUSTING COMMUNICATION GAPS RELATED TO RECEIVING PAGING MESSAGES

(71) Applicant: Nokia Technologies Oy, Espoo (FI)

(72) Inventors: Faranaz SABOURI-SICHANI, Aalborg (DK); Srinivasan SELVAGANAPATHY, Bangalore (IN); Frank FREDERIKSEN, Aalborg (DK); Laura Luque SANCHEZ, Aalborg (DK); Aby KANNEATH ABRAHAM, Bangalore (IN)

(21) Appl. No.: 18/552,125

(22) PCT Filed: Mar. 18, 2022
(86) PCT No.: PCT/EP2022/057097

§ 371 Date: Sep. 22, 2023

(30) Foreign Application Priority Data
Mar. 30, 2021 (IN) 202141014428

(51) Int. Cl. H04W 76/25; H04W 88/06

(52) U.S. Cl. CPC H04W 76/25; H04W 88/06

(57) ABSTRACT

A methods and apparatuses for communication are disclosed. The method comprises maintaining (600) a connected state with a first network with a first subscription identity used by the apparatus; maintaining (602) an inactive or idle state with a second network with a second subscription identity used by the apparatus, communicating (604) with the first network regarding the start, length and periodicity parameters of one or more communication gaps related to activities on the second network, receiving (606) from the first network one or more configurations of communication gaps and transmitting (608) to the first network information on a gap configuration or a change of one or more parameters in a gap configuration.

### FIELD

The exemplary and non-limiting embodiments of the disclosure relate generally to wireless communication systems. Embodiments of the disclosure relate especially to apparatuses and methods in wireless communication networks.

### BACKGROUND

Wireless communication systems are under constant development. One aspect under development is terminal devices having more than one subscription identities. There may be users who have the need to utilise more than one subscription in a substantially same terminal device. For example, one subscription maybe for home use and another for work. Typically, while one subscription is active other subscriptions are inactive or idle. Signalling traffic between the network and the subscriptions of the terminal device should be handled in an efficient manner.

### SUMMARY

The following presents a simplified summary of the disclosure in order to provide a basic understanding of some aspects of the disclosure. This summary is not an extensive overview of the disclosure. It is not intended to identify key/critical elements of the disclosure or to delineate the scope of the disclosure. Its sole purpose is to present some concepts of the disclosure in a simplified form as a prelude to a more detailed description that is presented later.

According to an aspect of the present disclosure, there is provided an apparatus in a communication system comprising at least one processor; and at least one memory including computer program code, the at least one memory and computer program code configured to, with the at least one processor, cause the apparatus to: maintain a connected state with a first network with a first subscription identity used by the apparatus; maintain an inactive or idle state with a second network with a second subscription identity used by the apparatus; communicate with the first network regarding the start, length and periodicity parameters of one or more communication gaps related to activities on the second network; receive from the first network one or more gap configurations of communication gaps; transmit to the first network information on a gap configuration or a change of one or more parameters in a gap configuration.

According to an aspect of the present disclosure, there is provided an apparatus in a communication system comprising at least one processor; and at least one memory including computer program code, the at least one memory and computer program code configured to, with the at least one processor, cause the apparatus to: maintain a connected state with a terminal device; communicate with the terminal device regarding start, length, and periodicity parameters of one or more communication gaps of the terminal device; transmit one or more gap configurations of communication gaps to the terminal device; receive from the terminal device information on a gap configuration determined by the terminal device or a change of one or more parameters in a gap configuration.

According to another aspect of the present disclosure, there is provided a method in an apparatus, comprising: maintaining a connected state with a first network with a first subscription identity used by the apparatus; maintaining an inactive or idle state with a second network with a second subscription identity used by the apparatus; communicating with the first network regarding the start, length and periodicity parameters of one or more communication gaps related to activities on the second network; receive from the first network one or more gap configurations of communication gaps; transmitting to the first network information on a gap configuration or a change of one or more parameters in a gap configuration.

According to another aspect of the present disclosure, there is provided a method in a network element, comprising: maintaining a connected state with a terminal device; communicating with the terminal device regarding start, length, and periodicity parameters of one or more communication gaps of terminal device; transmit one or more gap configurations of communication gaps to the terminal device; receiving from the terminal device information on a gap configuration determined by the terminal device or a change of one or more parameters in a gap configuration.

According to another aspect of the present disclosure, there is provided a computer program comprising instructions for causing an apparatus at least to: maintain a connected state with a first network with a first subscription identity used by the apparatus; maintain an inactive or idle state with a second network with a second subscription identity used by the apparatus; communicate with the first network regarding the start, length, and periodicity parameters of one or more communication gaps related to activities on the second network; receive from the first network one or more gap configurations of communication gaps; transmit to the first network information on a gap configuration or a change of one or more parameters in a gap configuration.

According to another aspect of the present disclosure, there is provided a computer program comprising instructions for causing an apparatus at least to: maintain a connected state with a terminal device; communicate with the terminal device regarding start, length, and periodicity parameters of one or more communication gaps of the terminal device; transmit one or more gap configurations of communication gaps to the terminal device; receive from the terminal device information on a gap configuration determined by the terminal device or a change of one or more parameters in a gap configuration.

One or more examples of implementations are set forth in more detail in the accompanying drawings and the description below. Other features will be apparent from the description and drawings, and from the claims. The embodiments and/or examples and features, if any, described in this specification that do not fall under the scope of the independent claims are to be interpreted as examples useful for understanding various embodiments of the disclosure.

### LIST OF DRAWINGS

Embodiments of the present disclosure are described below, by way of example only, with reference to the accompanying drawings, in which

FIGS. 1 and 2 illustrate examples of simplified system architecture of a communication system;

FIG. 3 illustrates an example of a terminal device with two subscriber identities;

FIG. 4 illustrates an example of paging timing;

FIGS. 5A and 5B illustrates examples of synchronization requirements in different conditions;

FIGS. 6A, 6B, 7A, 7B, 7C and 7D are flowcharts illustrating some embodiments;

FIGS. 8A, 8B and 8C illustrate embodiments of different configurations;

FIGS. 9A and 9B are signalling charts illustrating some embodiments; and

FIGS. 10, 11A and 11B illustrate simplified examples of apparatuses applying some embodiments of the disclosure.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may also contain features, structures, units, modules etc. that have not been specifically mentioned.

Some embodiments of the present disclosure are applicable to a user terminal, a communication device, a base station, eNodeB, gNodeB, a distributed realisation of a base station, a network element of a communication system, a corresponding component, and/or to any communication system or any combination of different communication systems that support needed functionality.

The protocols used, the specifications of communication systems, servers and user equipment, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. The embodiments may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

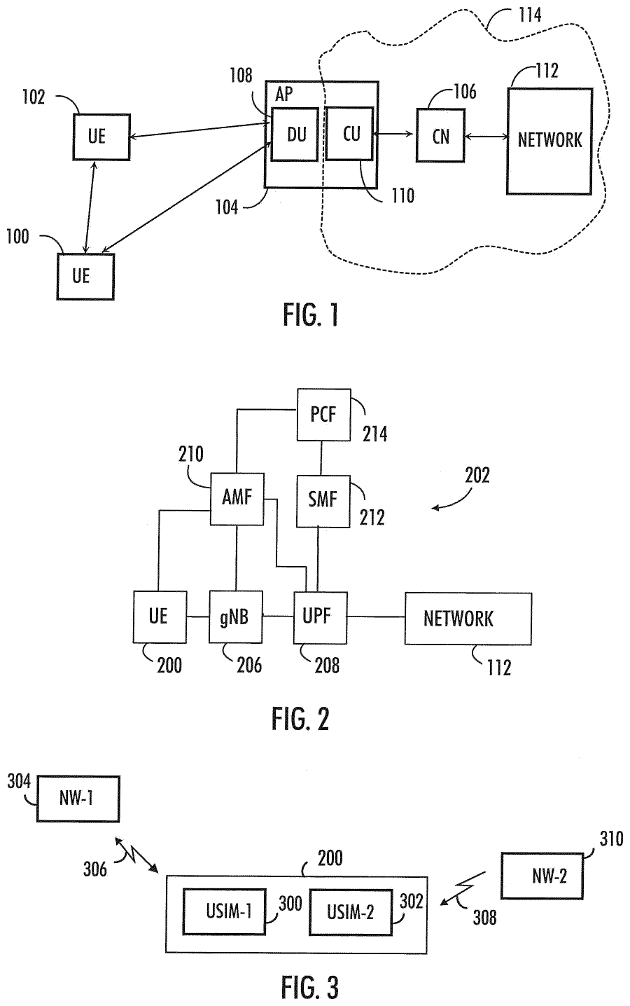

FIG. 1 depicts examples of simplified system architectures showing some elements and functional entities, all or some being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows devices 100 and 102. The devices 100 and 102 are configured to be in a wireless connection on one or more communication channels with a node 104. The node 104 is further connected to a core network 106. In one example, the node 104 may be an access node such as (e/g)NodeB serving devices in a cell. In one example, the node 104 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 106 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one ore more external packet data networks, and to a mobile management entity (MME) or access mobility management function (AMF), for controlling access and mobility of the devices.

Exemplary embodiments of a device are a subscriber unit, a user device, a user equipment (UE), a user terminal, a terminal device, a mobile station, a mobile device, etc

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or in some embodiments a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, e.g. below 6 GHz or above 24 GHz, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, 6 or above 24 GHz-cmWave and mmWave). One of the concepts considered to be used in 5G networks is network slicing in which multiple independent and dedicated virtual sub-networks (network instances) may be created within the substantially same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 108) and non-real time functions being carried out in a centralized manner (in a centralized unit, CU 110).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or NodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). At least one satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)NodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are needed to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

FIG. 2 illustrates an example of a communication system based on 5G network components. A user terminal or user equipment 200 communicating via a 5G network 202 with a data network 112. The user terminal 200 is connected to a Radio Access Network RAN node, such as (e/g)NodeB 206 which provides the user terminal with a connection to the network 112 via one or more User Plane Functions, UPF 208. The user terminal 200 is further connected to Core Access and Mobility Management Function, AMF 210, which is responsible for handling connection and mobility management tasks and can be seen from this perspective as the 5G version of Mobility Management Entity, MME, in LTE. The 5G network further comprises Session Management Function, SMF 212, which is responsible for subscriber sessions, such as session establishment, modify and release, and a Policy Control Function, PCF 214 which is configured to govern network behavior by providing policy rules to control plane functions.

In general, terminal device (or user terminal, user equipment, UE) hardware has a unique identifier. The identifier may be denoted as the permanent equipment identifier, PEI, or international mobile equipment identifier, IMEI.

Terminal device wishing to utilise services of a wireless communication system such as a cellular network, needs to have a subscription from the operator of the communication system. Typically, a subscription is bounded to a physical Universal Subscriber Identity Module, USIM, card and the subscription can be identified by a unique subscription permanent identifier, SUPI, denoted also an international mobile subscriber identity, IMSI. SUPI consists of the mobile country code (MCC), mobile network code (MNC), and the mobile subscription identification number (MSIN).

There are also so-called embedded USIMs or electronic SIMs, eSIM, available. An eSIM is a digital USIM that allows the owner to activate a subscription to a communication system without having to use a physical USIM card.

In most cases, a terminal device has one subscriber identity, stored in the USIM card inserted in the terminal. However, there are numerous terminal devices on the market which have more than one slot for USIM cards or eSIM support and are capable of supporting multiple subscriber identities. These terminal devices may be denoted as multi-USIM (MUSIM) devices. As of now, MUSIM terminal device usually may have two supported SIMs, but the amount of MUSIM terminal devices supporting more than two SIMs is expected to increase. In following, for simplicity, a terminal device having two subscriber identities (USIMs) installed is assumed. However, embodiments described below will work as well with terminal devices having more than two subscriber identities.

A MUSIM terminal device registers to the one or more networks using one or more subscription identities stored in the respective USIMs. The subscription identities are associated with respective radio protocol stack instances, which can be in any of the Radio Resource Control, RRC, states RRC_IDLE, RRC_INACTIVE, or RRC_CONNECTED with the network corresponding to their subscription.

The behaviour of a MUSIM device with respect to the simultaneous handling of multiple USIMs may depend on the capabilities of the terminal. Three types may be defined as follows:
Type 1: SingleRx/SingleTx: The terminal is capable of receiving traffic from one network and and/or transmitting traffic to one network at a time.
Type 2: DualRx/SingleTx: The terminal is capable of simultaneously receiving traffic from two networks but can transmit to one network at a time.
Type 3: DualRx/DualTx: The terminal is capable of simultaneously receiving and/or transmitting to/from two networks.

FIG. 3 illustrates an example situation. In this example, the terminal device 200 is a MUSIM device with two subscriber identities, USIM-1 300 and USIM-2 302. Assume that the USIM-1 is in connected mode 306 with a first network, NW-1 304 and in idle mode or RRC-INACTIVE with USIM-2 with a second network, NW-2 310.

SingleRX/singleTX devices cannot receive paging or perform other idle/inactive mode reception activities in one USIM while being in RRC_connected mode in another USIM. However, especially paging monitoring has to happen at fixed paging occasions (PO) and has high priority. Hence, the MUSIM device needs to momentarily interrupt its RRC connection when it has to monitor for paging periodically at the calculated paging POs.

In general, the location of paging frames (PF) and paging occasions (PO) is known by the terminal devices. In addition to monitoring paging messages, the terminal devices may need to wake up well before the PO to read a number of Synchronization Signal and Physical Broadcast Channel, PBCH, blocks (denoted as SSB bursts) to acquire time and frequency synchronization with the network to be able to decode the paging record in Physical Downlink Shared Channel PDSCH (obtaining time and frequency synchronization for being able to monitor for the Physical Downlink Control Channel PDCCH carrying the scheduling grant for the PDSCH with the paging record). Typically, the needed number of SSB bursts is from one to three.

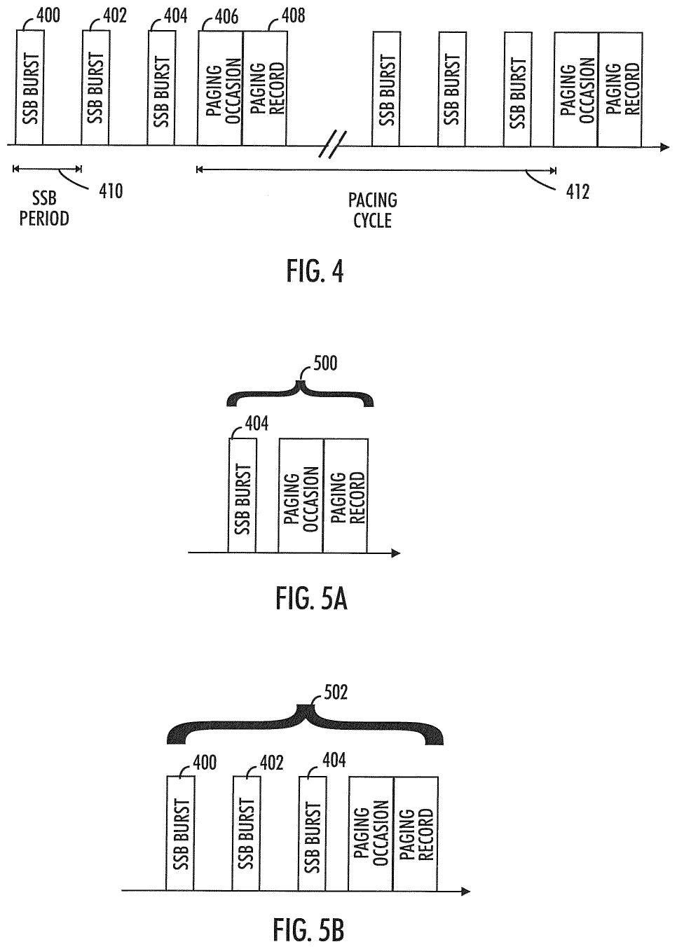

FIG. 4 illustrates an example of SSB and paging timing on PDSCH. The figure show some SSB bursts 400, 402, 404, a paging occasion PO 406 and Paging Record 408. SSB period 410 is the time between SSB bursts and Paging cycle 412 denotes time between paging occasions. The SSB periodicity is defined by the network and information is transmitted to the terminal devices.

As mentioned, SingleRX/singleTX terminal device cannot receive paging or perform other idle/inactive mode reception activities in one USIM while being in RRC_connected mode in another USIM. Therefore, a MUSIM device registered with two networks NW-1 and NW-2 and having an active connection at NW-1 needs to interrupt its RRC connection in NW-1 when it monitors for paging for NW-2. While this interruption is necessary due to the high priority of paging monitoring, the interruption time will have a negative impact on the on-going RRC connection and should be kept as small as possible.

The terminal device may request from the network for periodic communication gaps for paging monitoring and the length of the communication gap needs to take in to account the time needed to acquire time and frequency synchronization. The number of SSBs needed to obtain synchronization depends on radio channel conditions. The number is largest if the terminal device is measuring a low Signal to Interference and Noise Ratio, SINR, from the associated gNB of the network. Thus, the terminal device may need a single SSB burst or up to three SSB bursts (and even more in rare bad channel conditions). For example, the terminal device may need 1 SSB, 2 SSBs, or 3 SSBs in high, mid, or low SINR, respectively.

FIG. 5A illustrates an example where there is high SINR. Here one SSB burst 404 may be needed to obtain synchronization and the communication gap length 500 is short.

FIG. 5B illustrates an example where there is low SINR. Here the terminal device may need three SSB bursts 400, 402, 404 to obtain synchronization and the communication gap length 502 is larger.

Thus, when a terminal device requests for a communication gap, it has to consider the synchronization time in the requested communication gap duration. To request a communication gap for three SSB bursts in the communication gap duration when the terminal device is in good channel conditions is not efficient when it might need a single or two SSB bursts.

Thus, there is a need for a dynamic communication gap allocation which considers both the requirements of paging monitoring but also the interruption to the USIM in connected mode.

In an embodiment, one or more periodic communication gaps are requested by the terminal device and configured by the network or configured by the network without the request from the terminal device. Then the terminal device may dynamically inform a selected gap configuration among one or more configurations or request a change in gap length. The change in gap length may be requested by the terminal device for one or more gap occurrences in a configured periodic gap.

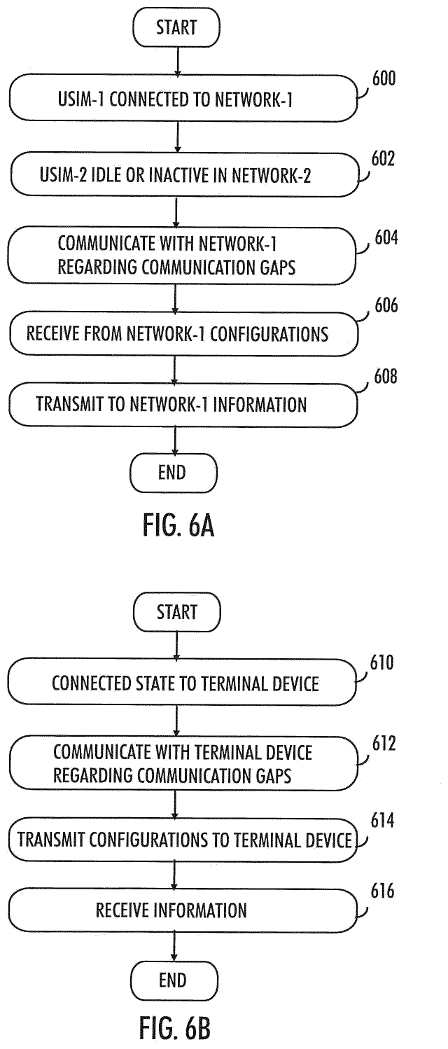

The flowchart of FIG. 6A illustrates an embodiment. The flowchart illustrates an example of the operation of an apparatus. In an embodiment, the apparatus may be a terminal device or a part of a terminal device.

In step 600, the terminal device is in a connected state with a first network with a first subscription identity used by the apparatus. Referring to FIG. 3, the USIM-1 is in connected mode to NW-1.

In step 602, the terminal device is in inactive or idle state with a second network with a second subscription identity used by the apparatus. Referring to FIG. 3, the USIM-2 is idle or inactive regarding NW-2. In terms of FIG. 3, NW-1 is the first network and NW-2 is the second network.

In step 604, the terminal device is configured to communicate with the first network regarding the start, length, and periodicity parameters of one or more communication gaps related to activities on the second network. In an embodiment, the activities are related to receiving paging messages.

In step 606, the terminal device is configured to receive from the first network one or more gap configurations of communication gaps.

In step 608, the terminal device is configured to transmit to the first network information on a gap configuration or a change of one or more parameters in a gap configuration.

The flowchart of FIG. 6B illustrates an embodiment. The flowchart illustrates an example of the operation of an apparatus. In an embodiment, the apparatus may be a network element such as an (e/g)NodeB of a Radio Access Network, for example, or a part of an (e/g)NodeB.

In step 610, the network element is configured to maintain a connected state with a terminal device. In terms of FIG. 3, UE-1 is in connected mode with NW-1.

In step 612, the network element is configured to communicate with the terminal device regarding start, length, and periodicity parameters of one or more communication gaps of the terminal device.

In step 614, the network element is configured to transmit one or more gap configurations of communication gaps to the terminal device.

In step 616, the network element is configured to receive from the terminal device information on the selected gap configuration or change of one or more parameters in the configuration.

In an embodiment, the communication of step 612 comprises the transmission of gap configurations in step 614, the steps may be combined. Thus, the first network may transmit a plurality of gap configurations to the terminal device in step 614 where after it receives from the terminal device information on one or more gap configurations selected by the terminal device in step 616.

In an embodiment, the proposed solution enables to optimize the duration of the periodic communication gaps so that the minimum gap needed may be used for synchronization depending on the radio conditions and thereby improve the performance of the RRC connected terminal device, since it can continue with its normal activity/traffic during longer time.

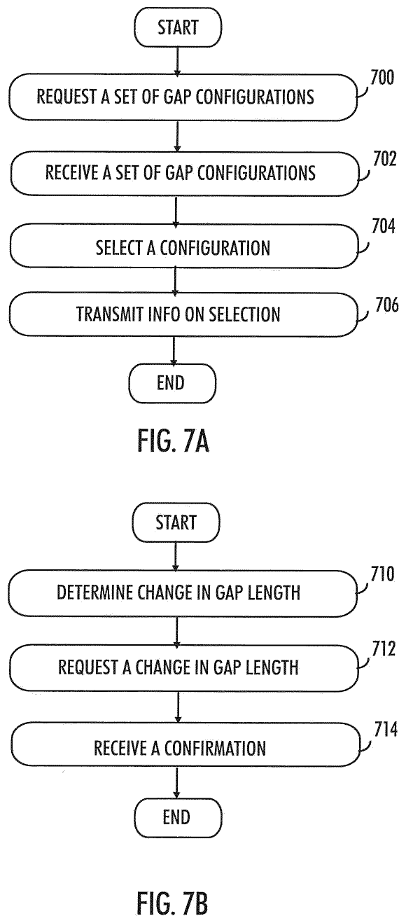

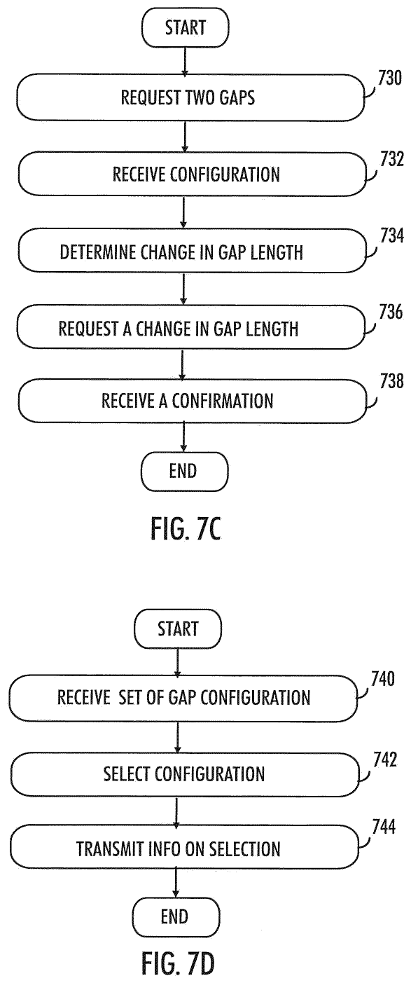

The flowchart of FIG. 7A illustrates an embodiment. The flowchart illustrates an example of the operation of an apparatus. In an embodiment, the apparatus may be a terminal device or a part of a terminal device.

In step 700, the terminal device is configured to request from the first network a set of gap configurations, the gap configurations providing different gap parameters. The terminal device may request one or more sets of gap configurations corresponding to the number of necessary SSB bursts for synchronization toward the network.

The first network may be configured to accept subset of gap configurations in response to terminal device request and assign a unique identifier for at least one and the default gap configuration that first network will assume without further indication from the terminal device.

In step 702, the terminal device is configured to receive acceptance from the first network regarding the set of gap configurations.

In an embodiment, the terminal device may inform the network that one configuration of the set of configurations may be used.

In step 704, the terminal device is configured to determine which gap configuration to use based on usage of earlier communication gaps and/or radio link condition of serving cell. The terminal device may estimate dynamically, based on radio link conditions of serving cell and/or last PO monitoring how many SSB bursts it may need.

In step 706, the terminal device is configured to transmit information on the determined gap configuration to the first network.

The flowchart of FIG. 7B illustrates an embodiment. The flowchart illustrates an example of the operation of an apparatus. In an embodiment, the apparatus may be a terminal device or a part of a terminal device.

In this alternative embodiment, the terminal device may request one gap. This can be used if more than one gap configuration for a given purpose is not accepted by the network.

In an embodiment, the terminal device can request its gap based on best case, e.g. with a single SSB burst for synchronization or based on current radio condition of idle mode network, NW-2 in the example of FIG. 3.

In step 710, the terminal device is configured to estimate dynamically, based on its past serving cell measurements and/or last PO monitoring, that it needs to increase the number of SSB bursts. Thus a change in communication gap length is required.

In step 712, the terminal device is configured to request from the first network an extension in the length of a communication gap. The terminal device requests the network to increase the gap duration with an extension at the gap start or gap end. This request regarding the gap duration may apply not the whole configuration of periodic communication gaps but only for one or more communication gap occurrences in the series of periodic communication gaps.

In an embodiment, the terminal device may also request a reduction in the length of one or more communication gaps.

In case if the terminal device misses PO monitoring due to need for additional SSB acquisition or if there is decoding failure for PO monitoring due to limited SSB acquisition restriction of gap, UE may report the substantially same after PO monitoring via any uplink MAC signaling to adjust the gap start.

In step 714, the terminal device is configured to receive from the first network confirmation of the length of a communication gap.

The flowchart of FIG. 7C illustrates an embodiment. The flowchart illustrates an example of the operation of an apparatus. In an embodiment, the apparatus may be a terminal device or a part of a terminal device.

Also, in this embodiment, the terminal device can request its communication gap based on best case, e.g. with a single SSB burst for synchronization or based on current radio condition of idle mode network, NW-2 in the example of FIG. 3.

In step 730, the terminal device is configured to request from the network at least two separate communication gaps. In an embodiment, the gaps comprise a communication gap related to receiving paging messages from the second network and a communication gap for synchronization with the second network.

Thus in this embodiment, the terminal device can request two periodic communication gaps. For example, one communication gap may be for the paging occasions PO and a separate one may be for the synchronization placed at the first of the three SSB's and then dynamically request the network to increase the gap duration with an extension at the gap end for the synchronization gap.

In general, a terminal device in RRC_idle or RRC_inactive should also perform RRM measurements for cell reselection and is free to plan these measurements on its own. Normally, the terminal device will do radio resource management measurements just before or after the PO in order to save power by collecting its activities together. A gap extension at any end of an already configured communication gap can then be requested for measurements as well.

In step 732, the terminal device is configured to receive from the first network a configuration with at least two communication gaps.

In step 734, the terminal device is configured to determine change in a gap length based on usage of earlier communication gaps and/or radio link condition of serving cell.

In step 736, the terminal device is configured to request from the first network an extension in the length of the communication gap for synchronization, the extension located at the start or end of the gap.

In step 738, the terminal device is configured to receive from the first network confirmation of the length of the gap.

The flowchart of FIG. 7D illustrates an embodiment. The flowchart illustrates an example of the operation of an apparatus. In an embodiment, the apparatus may be a terminal device or a part of a terminal device.

In an embodiment, the network side proposes the possible communication gaps or gap configurations and lets the terminal device to select and inform the appropriate ones.

In step 740, the terminal device is configured to receive from the network a set of gap configurations. The different gap configurations may have different number of gaps, different lengths of gaps, different distances between gaps and/or different offset related to transmission frame. The distance between gaps may be defined either as distance between starting points (from start of one gap to start of next gap) or as indication of non-gap between gaps (from end of gap to start of next gap).

In step 742, the terminal device is configured to determine which gap configuration to use based on usage of earlier communication gaps and/or radio link condition of serving cell. In an embodiment, the terminal device determines from the provided gap configurations the preferred configuration or configurations.

In step 744, the terminal device is configured to transmit information on the determined gap configuration to the first network. In an embodiment, the terminal device indicates the decision or recommendation to the network which confirms the request from the terminal device. In an embodiment, the terminal device may, in a dynamic manner, indicate to the network which of the configured sets the terminal device is actively following, based on its observed radio conditions towards the other network from which paging messages are monitored.

In above embodiments, the terminal device is configured to inform the network information about the gap configuration which is being used, or adjustment of gap configuration, or selecting from a pre-configured set of configurations or parameters. In an embodiment, this information may be sent utilising Uplink Control Information, UCI, or Medium Access Control-Control Element, MAC-CE, based indication. This ensures quick response.

The terminal device may inform the network utilising a UCI or MAC CE message about which gap configuration needs to be active from a set of gap configuration as in FIG. 7A, or a change to extend a gap at gap start as in FIG. 7B or gap end as in FIG. 7C.

The terminal device may be configured to dynamically estimate, based on its past serving cell measurements and/or last PO monitoring whether it may need to increase the number of SSB bursts and inform the network about the utilized gap or request the network to increase the gap duration with an extension at the gap start or end.

In an embodiment, the terminal device may provide the network performance of last given number of PO monitoring, based on the configured gaps to allow the network to adjust the gap configuration. This messaging may be implemented at Radio Resource Control, RRC, level. In this case the adaptation will be slower than above methods.

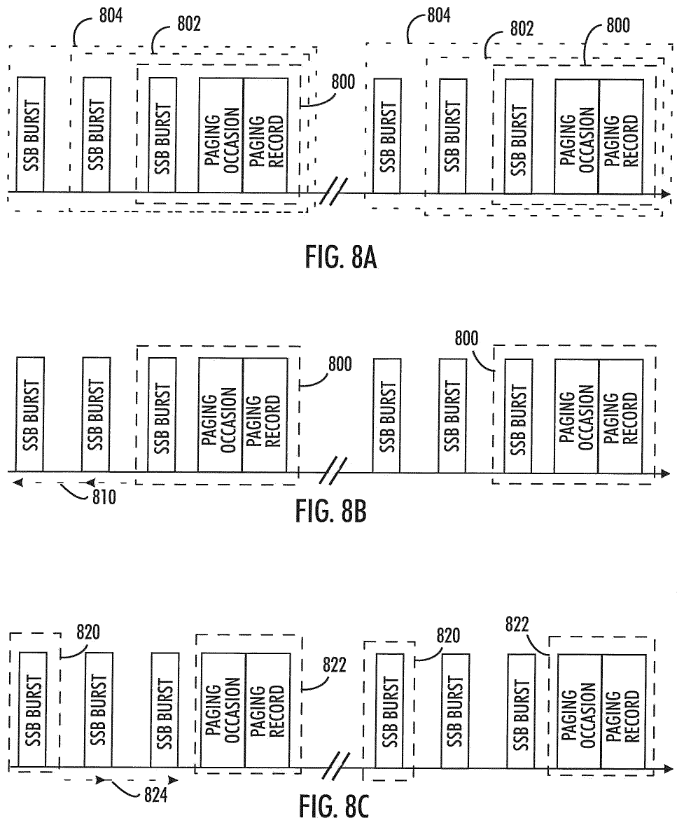

FIGS. 8A, 8B and 8C illustrate embodiments of different configurations of periodic gap request corresponding to FIGS. 7A, 7B and 7C.

FIG. 8A illustrates the embodiment of FIG. 7A. In FIG. 8A there are gap configurations 800, 802, 804 having different number of SSB bursts included.

FIG. 8B illustrates the embodiment of FIG. 7B. In FIG. 8B there is a gap 800. The terminal device may request a dynamic gap extension 810 at the gap start.

FIG. 8C illustrates the embodiment of FIG. 7C. In FIG. 8C there are two gaps, gap 820 for synchronization and gap 822 for paging occasion. The terminal device may request a dynamic gap extension 824 at the gap end.

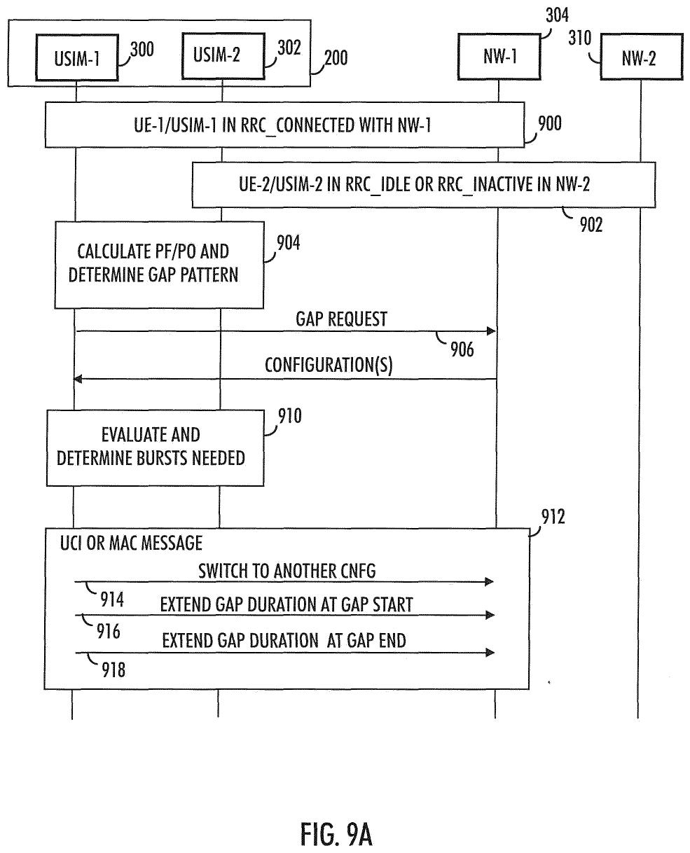

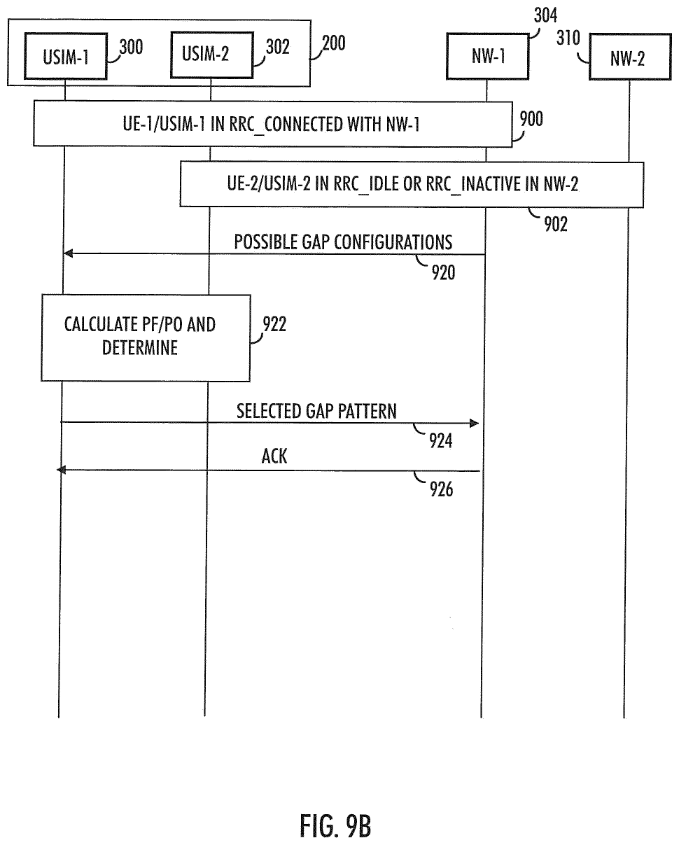

FIG. 9A is a signalling chart illustrating an example of signalling between the terminal device and the network corresponding to FIGS. 7A, 7B and 7C.

In this example, the terminal device 200 is configured to maintain a connected state 900 with a first network NW-1 304 with a first subscription identity USIM-1 300 used by the apparatus.

The terminal device 200 is further configured to maintain an inactive or idle state 902 with a second network NW-2 with a second subscription identity USIM-2 302 used by the apparatus.

The terminal device is configured to calculate 904 paging frame, PF, and paging occasion, PO, location and make a communication gap pattern decision. The gap pattern decision may be to request multiple gap patterns (as in FIG. 7A), or a single gap with dynamic extension either at the start or the end of the gap (as in FIG. 7B) or two gaps with dynamic extension either at the start or the end of one of the gaps (FIG. 7C).

The terminal device then transmits a communication gap pattern request 906 to the network NW-1 304.

The network transmits 908 information on configuration or configurations to the terminal device.

The terminal device is configured to estimate 910 dynamically, based on its past serving cell measurements and/or last PO monitoring how many SSB bursts it may need.

The terminal device then transmits 912, utilising a UCI or MAC CE message, information about the communication gap. Depending on the situation, the message may concern switching 914 to another gap configuration, extending gap duration at gap start 916 or at the gap end of the synchronization gap 918.

FIG. 9B is a signalling chart illustrating an example of signalling between the terminal device and the network corresponding to FIG. 7D.

Also in this example, the terminal device 200 is configured to maintain a connected state 900 with a first network NW-1 304 with a first subscription identity USIM-1 300 used by the apparatus.

The terminal device 200 is further configured to maintain an inactive or idle state 902 with a second network NW-2 with a second subscription identity USIM-2 302 used by the apparatus.

The terminal device is configured to receive 920 from the network NW-1 304 a set of possible gap configurations. The different gap configurations may have different number of communication gaps, different lengths of gaps, different distances between gaps and/or different offset related to transmission frame. The distance between gaps may be defined either as distance between starting points (from start of one gap to start of next gap) or as indication of non-gap between gaps (from end of gap to start of next gap).

The terminal device is the configured to calculate 922 paging frame, PF, and paging occasion, PO, location and evaluate serving cell SINR and/or last PO monitoring and determine how many SSB bursts it may need for time and frequency synchronization and select a suitable gap pattern from the options received from the network NW-1.

The terminal device is configured to transmit 924 information on the selected gap configuration to the network NW-1, which acknowledges 926 the message.

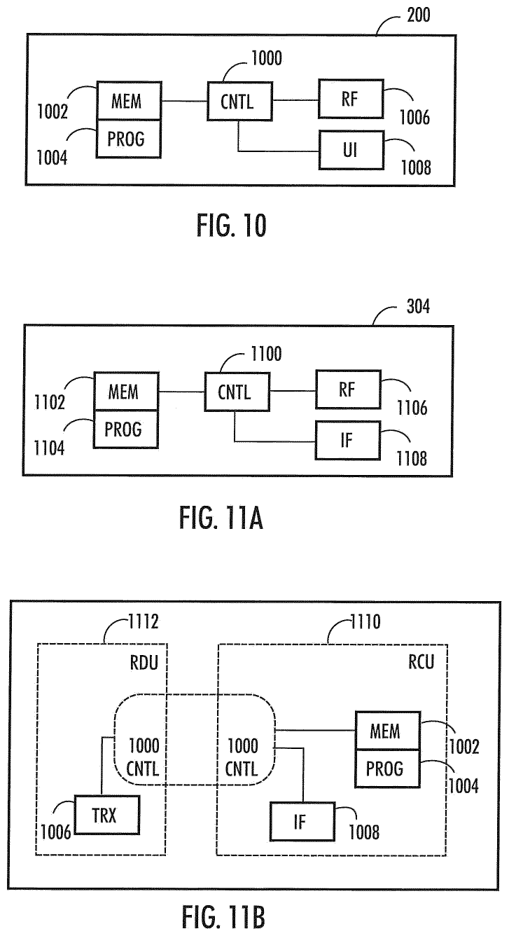

FIGS. 10, 11A and 11B illustrate an embodiment. The figures illustrate simplified examples of apparatuses applying embodiments of the disclosure. It should be understood that the apparatuses are depicted herein as examples illustrating some embodiments. It is apparent to a person skilled in the art that the apparatuses may also comprise other functions and/or structures and not all described functions and structures are needed. Although the apparatuses have been depicted as one entity, different modules and memory may be implemented in one or more physical or logical entities.

FIG. 10 illustrates an embodiment. The figure illustrates a simplified example of an apparatus 200 applying embodiments of the disclosure. In some embodiments, the apparatus may be a terminal device or a part of a terminal device.

The apparatus 200 of the example includes a control circuitry 1000 configured to control at least part of the operation of the apparatus.

The apparatus may comprise a memory 1002 for storing data. Furthermore, the memory may store software 1004 executable by the control circuitry 1000. The memory may be integrated in the control circuitry.

The apparatus may comprise one or more interface circuitries 1006, 1008. The interface circuitries are operationally connected to the control circuitry 1000. An interface circuitry 1006 may be a set of transceivers configured to communicate with network, for example a RAN node, such as an (e/g)NodeB of a wireless communication network. The interface circuitry may be connected to an antenna arrangement (not shown). The apparatus may also comprise a connection to a transmitter instead of a transceiver. The apparatus may further comprise a user interface 1008.

In an embodiment, the software 1004 may comprise a computer program comprising program code means configured to cause the control circuitry 1000 of the apparatus to realise at least some of the embodiments described above.

FIG. 10A illustrates an embodiment. The figure illustrates a simplified example of an apparatus 304 applying embodiments of the disclosure. In some embodiments, the apparatus may be a network node or (e/g)NodeB, or a part of a network node or (e/g)NodeB.

The apparatus 304 of the example includes a control circuitry 1100 configured to control at least part of the operation of the apparatus.

The apparatus may comprise a memory 1102 for storing data. Furthermore, the memory may store software 1104 executable by the control circuitry 1100. The memory may be integrated in the control circuitry.

The apparatus may comprise one or more interface circuitries 1106, 1108. The interface circuitries are operationally connected to the control circuitry 1100. An interface circuitry 1106 may be a set of transceivers configured to communicate with terminal devices of a wireless communication network. The interface circuitry may be connected to an antenna arrangement (not shown). The apparatus may also comprise a connection to a transmitter instead of a transceiver. The interface 1108 may connect the apparatus to other corresponding apparatuses or to core network, for example.

In an embodiment, the software 1104 may comprise a computer program comprising program code means configured to cause the control circuitry 1100 of the apparatus to realise at least some of the embodiments described above.

In an embodiment, as shown in FIG. 11B, at least some of the functionalities of the apparatus of FIG. 11A may be shared between two physically separate devices, forming one operational entity. Therefore, the apparatus may be seen to depict the operational entity comprising one or more physically separate devices for executing at least some of the described processes. Thus, the apparatus of FIG. 11B, utilizing such shared architecture, may comprise a remote control unit RCU 1110, such as a host computer or a server computer, operatively coupled (e.g. via a wireless or wired network) to a remote distributed unit RDU 1112 located in the base station. In an embodiment, at least some of the described processes may be performed by the RCU 1110. In an embodiment, the execution of at least some of the described processes may be shared among the RDU 1112 and the RCU 1110.

In an embodiment, the RCU 1110 may generate a virtual network through which the RCU 1112 communicates with the RDU 1112. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (e.g. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RDU and the RCU. In practice, any digital signal processing task may be performed in either the RDU or the RCU and the boundary where the responsibility is shifted between the RDU and the RCU may be selected according to implementation.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

An embodiment provides a computer program embodied on a distribution medium, comprising program instructions which, when loaded into an electronic apparatus, are configured to control the apparatus to execute the embodiments described above.

The computer program may be in source code form, object code form, or in some intermediate form, and it may be stored in some sort of carrier, which may be any entity or device capable of carrying the program. Such carriers include a record medium, computer memory, read-only memory, and a software distribution package, for example. Depending on the processing power needed, the computer program may be executed in a single electronic digital computer or it may be distributed amongst several computers.

The apparatus may also be implemented as one or more integrated circuits, such as application-specific integrated circuits ASIC. Other hardware embodiments are also feasible, such as a circuit built of separate logic components. A hybrid of these different implementations is also feasible. When selecting the method of implementation, a person skilled in the art will consider the requirements set for the size and power consumption of the apparatus, the necessary processing capacity, production costs, and production volumes, for example.

In an embodiment, an apparatus comprises means for maintaining a connected state with a first network with a first subscription identity used by the apparatus; means for maintaining an inactive or idle state with a second network with a second subscription identity used by the apparatus; means for communicating with the first network regarding the start, length and periodicity parameters of one or more communication gaps related to activities on the second network; means for receiving from the first network one or more configurations of communication gaps and means for transmitting to the first network information on a gap configuration or a change of one or more parameters in a gap configuration.

In an embodiment, an apparatus comprises means for maintaining a connected state with a terminal device; means for communicating with the terminal device regarding start, length, and periodicity parameters of one or more communication gaps of the terminal device; means for transmit one or more gap configurations of communication gaps to the terminal device; and means for receiving from the terminal device information on a gap configuration or a change of one or more parameters in a gap configuration.

It will be obvious to a person skilled in the art that, as the technology advances, the inventive concept can be implemented in various ways. The disclosure and its embodiments are not limited to the examples described above but may vary within the scope of the claims.

### List of Abbreviations Used in this Document

3GPP 3rd Generation Partnership Project
AMF access mobility management function
CN core network
CPS cyber-physical system
CU centralized unit
DU distributed unit
ESIM electronic subscriber identification module
GEO geostationary earth orbit
HNB-GW home nodeB gateway
ICT information and communications technology
IMEI international mobile equipment identifier
IMS Internet Protocol multimedia subsystems
IOT Internet of Things
LEO low earth orbit
LTE, long term evolution
LTE-A long term evolution advanced
M2M machine-to-machine
MAC-CE Medium Access Control-Control Element
MANET mobile ad-hoc network
MCC mobile country code
MEC multi-access edge computing
MIMO multiple input-multiple output
MME mobile management entity
mMTC massive machine-type communications
MNC mobile network code
MSIN mobile subscription identification number
MUSIM multi universal subscriber identification module
NFV network function virtualization
NGC next generation core
NR, 5G new radio
NW Network
PBCH Physical Broadcast Channel
PCF Policy Control Function
PCS personal communications services
PDA personal digital assistant
PDCCH Physical Downlink Control Channel
PDSCH Physical Downlink Shared Channel
PEI permanent equipment identifier
PF paging frame
PO paging occasion
RAN radio access network
RCU remote control unit
RDU remote distributed unit
RRC Radio Resource Control
SDN software defined networking
S-GW+P-GW serving and packet data network gateway
SINR Signal to Interference and Noise Ratio
SMF Session Management Function
SSB Synchronization Signal and Physical Broadcast Channel block
SUPI subscription permanent identifier
UCI Uplink Control Information
UE user equipment
UMTS universal mobile telecommunications system
UPF user plane function
UPF User Plane Function
USIM universal subscriber identification module
UTRAN universal mobile telecommunications system radio access network
UWB ultra-wideband
VoIP Voice over Internet Protocol
WCDMA wideband code division multiple access
WiFi wireless local area network
WiMAX worldwide interoperability for microwave access
WLAN, wireless local area network

1. An apparatus in a communication system comprising at least one processor; and at least one memory including computer program code, the at least one memory and computer program code configured to, with the at least one processor, cause the apparatus to:
maintain a connected state with a first network with a first subscription identity used by the apparatus;
maintain an inactive or idle state with a second network with a second subscription identity used by the apparatus;
communicate with the first network regarding the start, length and periodicity parameters of one or more communication gaps related to activities on the second network;
receive from the first network one or more gap configurations of communication gaps;
transmit to the first network information on a gap configuration or a change of one or more parameters in a gap configuration.

2. The apparatus of claim 1, the at least one memory and the computer program code configured to, with the at least one processor, cause the apparatus further to:
request from the first network a set of gap configurations, the configurations of the set providing different gap parameters;
receive from the first network a set of gap configurations;
determine which gap configuration to use based on usage of earlier communication gaps and/or radio link condition of serving cell;
transmit information on the determined gap configuration to the first network.

3. The apparatus of claim 1, the at least one memory and the computer program code configured to, with the at least one processor, cause the apparatus further to:
determine a change in a gap length based on usage of earlier communication gaps and/or radio link condition of serving cell;
request from the first network an extension in the length of a communication gap;
receive from the first network confirmation of the length of a communication gap.

4. The apparatus of claim 1, the at least one memory and the computer program code configured to, with the at least one processor, cause the apparatus further to:
request from the first network at least two separate communication gaps;
receive from the first network at least two communication gaps;
determine change in a gap length based on usage of earlier communication gaps and/or radio link condition of serving cell;
request from the first network an extension in the length of at least one of the gaps, the extension located at the start or end of the gap;
receive from the first network confirmation of the length of the gap.

5. The apparatus of claim 3, the at least one memory and the computer program code configured to, with the at least one processor, cause the apparatus further to:
request from the first network a reduction in the length of the configured gap or at least one of the configured gaps, the reduction located at the start or end of the gap;
receive from the first network confirmation of the length of the gap.

6. The apparatus of claim 1, the at least one memory and the computer program code configured to, with the at least one processor, cause the apparatus further to:
receive from the first network a set of gap configurations;
determine which gap configuration to use based on usage of earlier communication gaps and/or radio link condition of serving cell;
transmit information on the determined gap configuration to the first network.

7. The apparatus of claim 6, wherein different gap configurations have different number of gaps, different lengths of gaps, different distances between gaps and/or different offset related to transmission frame.

8. An apparatus in a communication system comprising at least one processor; and at least one memory including computer program code, the at least one memory and computer program code configured to, with the at least one processor, cause the apparatus to:
maintain a connected state with a terminal device;
communicate with the terminal device regarding start, length, and periodicity parameters of one or more communication gaps of the terminal device;
transmit one or more gap configurations of communication gaps to the terminal device;
receive from the terminal device information on a gap configuration determined by the terminal device or a change of one or more parameters in a gap configuration.

9. The apparatus of claim 8, the at least one memory and the computer program code configured to, with the at least one processor, cause the apparatus further to:
receive from the terminal device a request regarding a set of gap configurations, the gap configurations providing different gap parameters;
determine and transmit a set of gap configurations to the terminal device;
receive from the terminal device information on a gap configuration selected by the terminal device.

10. The apparatus of claim 8, the at least one memory and the computer program code configured to, with the at least one processor, cause the apparatus further to:
receive from the terminal device a request regarding an extension in the length of a communication gap, the extension located at the start or end of the gap;
determine and transmit to the terminal device confirmation of the length of a communication gap.

11. The apparatus of claim 8, the at least one memory and the computer program code configured to, with the at least one processor, cause the apparatus further to:
receive from the terminal device a request regarding at least two separate communication gaps;
transmit to the terminal device at least two configurations of communication gaps;
receive from the terminal device a request regarding an extension in the length of at least one of the configured gaps, the extension located at the start or end of the gap;
transmit to the terminal device confirmation of the length of the gap.

12. The apparatus of claim 8, the at least one memory and the computer program code configured to, with the at least one processor, cause the apparatus further to:
transmit to the terminal device a set of communication gap configurations;
receive from the terminal device information on gap configuration selected by the terminal device.

13. A method in an apparatus, comprising:
maintaining a connected state with a first network with a first subscription identity used by the apparatus;
maintaining an inactive or idle state with a second network with a second subscription identity used by the apparatus;
communicating with the first network regarding the start, length and periodicity parameters of one or more communication gaps related to activities on the second network;
receiving from the first network one or more gap configurations of communication gaps;
transmitting to the first network information on a gap configuration or a change of one or more parameters in a gap configuration.

14. The method of claim 13, further comprising:
requesting from the first network a set of gap configurations, the configurations of the set providing different gap parameters;
receiving from the first network a set of gap configurations;
determining which gap configuration to use based on usage of earlier communication gaps and/or radio link condition of serving cell;
transmitting information on the determined gap configuration to the first network.

15. The method of claim 13, further comprising:
determining a change in a gap length based on usage of earlier communication gaps and/or radio link condition of serving cell;
requesting from the first network an extension in the length of a communication gap, the extension located at the start of the gap;
receiving from the first network confirmation of the length of a communication gap.

16.-20. (canceled)
